(19) United States
(12) Patent Application Publication
(10) Pub. No.: US 2007/0164654 A1
(43) Pub. Date: Jul. 19, 2007

(54) Information processing apparatus

(76) Inventor: Yuichi Koga, Hachioji-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/604,304

(22) Filed: Nov. 27, 2006

(30) Foreign Application Priority Data
Nov. 30, 2005 (JP) 2005-346901

(51) Int. Cl. H01J 63/04; H01J 1/62

(52) U.S. Cl. 313/495

(57) ABSTRACT

According to one embodiment, an information processing apparatus includes a body, a display unit supported by the body, a light source provided in the display unit and including a first area in which a first light emitting element and a second light emitting element are arranged and a second area in which a third light emitting element and a fourth light emitting element are arranged, the third light emitting element being connected in series with the first light emitting element, the fourth light emitting element being connected in series with the second light emitting element, a first control circuit provided in the body to supply a first voltage to the first and third light emitting elements, and a second control circuit provided in the body to supply a second voltage to the second and fourth light emitting elements.

### CROSS-REFERENCE TO RELATED APPLICATIONS

This application is based upon and claims the benefit of priority from Japanese Patent Application No. 2005-346901, filed Nov. 30, 2005, the entire contents of which are incorporated herein by reference.

### BACKGROUND

1. Field

One embodiment of the invention relates to an information processing apparatus comprising a display unit including light emitting elements as a light source.

2. Description of the Related Art

In recent years, efforts have been made to develop a portable terminal apparatus comprising a display unit such as liquid crystal display (LCD) which includes, as a light source, light emitting elements such as light emitting diodes (LEDs) (Jpn. Pat. Appln. KOKAI Publication No. 2003-35893). LEDs generates less heat and lasts longer than other light sources such as fluorescent tubes. Recently, the emission efficiency of LEDs has also been sufficiently improved.

As shown in FIG. 1 of Jpn. Pat. Appln. KOKAI Publication No. 2003-35893, an LED is controlled by one LED control means. Normally, if the light source is composed of an LED, a plurality of LEDs are used. In this case, luminance may vary among LEDs. This disadvantageously results in uneven luminance, making it difficult to see images.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the appearance of an information processing apparatus according to an embodiment of the present invention;

FIG. 2 is an exemplary block diagram showing the exemplary system configuration of the information processing apparatus in FIG. 2;

FIG. 3 is an exemplary block diagram showing the exemplary configuration of an LED driving circuit and an LED group which are provided in the information processing apparatus in FIG. 1;

FIG. 4 is an exemplary diagram showing the configuration of a power supply control circuit and white LEDs in FIG. 3;

FIG. 5 is an exemplary diagram showing an exemplary display provided if white LEDs connected to any of the power supply control circuits fail to illuminate;

FIG. 6 is an exemplary diagram showing an example of a system circuit board on which GPU and power supply control circuits are implemented, a panel-side circuit board on which an LCD driver circuit and a white LED group are implemented, and cables through which a video signal and a driving voltage are transmitted to the panel-side circuit board;

FIG. 7 is an exemplary diagram showing an exemplary connection between the system circuit board and the panel-side circuit board;

FIG. 8 is an exemplary diagram showing an exemplary connection between the system circuit board and the panel-side circuit board;

FIG. 9 is an exemplary diagram showing an exemplary connection between the system circuit board and the panel-side circuit board;

FIG. 10 is an exemplary diagram showing an exemplary connection between the system circuit board and the panel-side circuit board for a display unit containing an SD card reader; and

FIG. 11 is an exemplary diagram showing an exemplary connection between the circuit board to which the video signal and driving voltage are transmitted and the circuit board on which white LEDs are implemented.

### DETAILED DESCRIPTION

Various embodiments according to the invention will be described hereinafter with reference to the accompanying drawings. In general, according to one embodiment of the invention, an information processing apparatus comprises a body, a display unit supported by the body, a light source provided in the display unit and including a first area in which a first light emitting element and a second light emitting element are arranged and a second area in which a third light emitting element and a fourth light emitting element are arranged, the third light emitting element being connected in series with the first light emitting element, the fourth light emitting element being connected in series with the second light emitting element, a first control circuit provided in the body to supply a first voltage to the first and third light emitting elements, and a second control circuit provided in the body to supply a second voltage to the second and fourth light emitting elements.

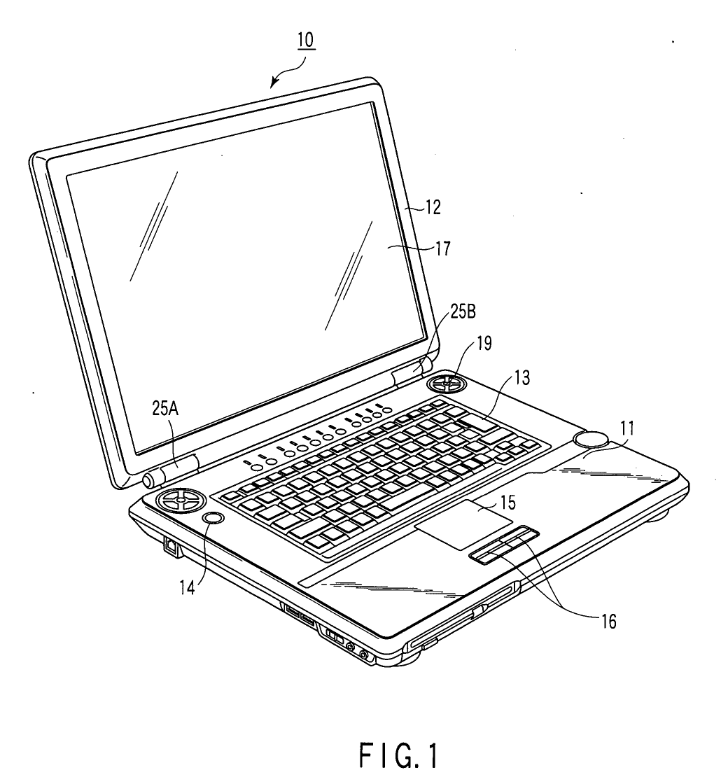

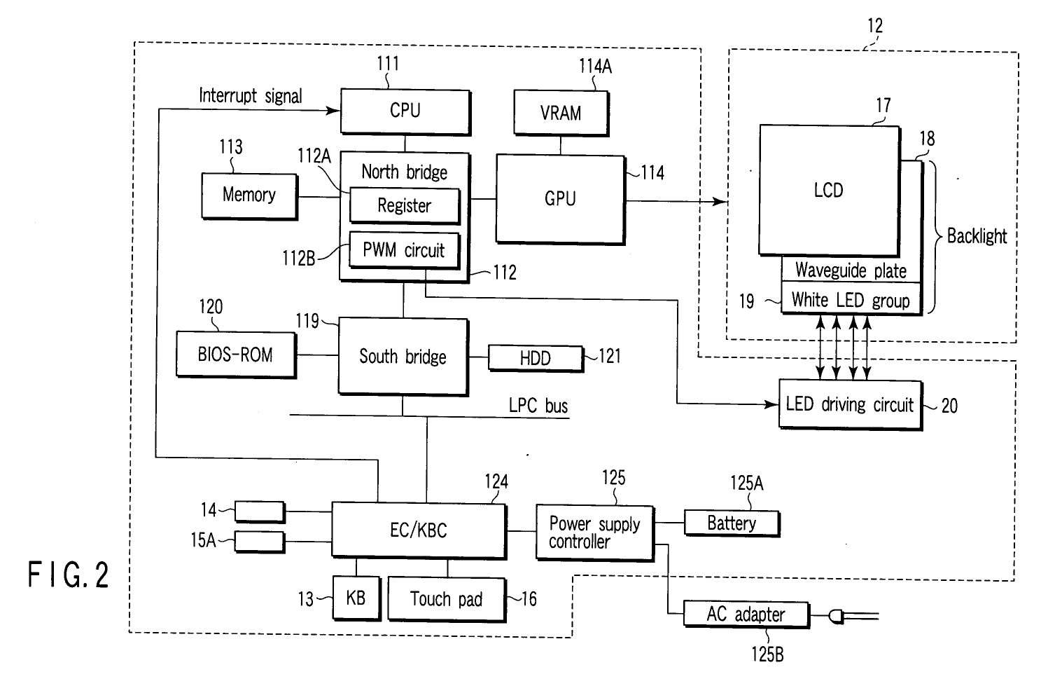

First, with reference to FIGS. 1 and 2, description will be given of configuration of an information processing apparatus according to an embodiment of the present invention. The information processing apparatus is implemented as a battery-drivable portable notebook personal computer 10.

FIG. 1 is a perspective view showing that a display unit of the notebook personal computer 10 is open. The computer 10 is composed of a computer body 11 and a display unit 12. A liquid crystal display (LCD) 17 and a display panel composed of a backlight are incorporated in the display unit 12. A display screen of The LCD 17 is located almost in the center of the display unit 12. The LCD 17 is composed of a transmissive liquid crystal panel. In the display unit 12, the backlight is placed behind the LCD 17. The backlight functions as a lighting device of the display unit 12. The backlight comprises a light emitting element such as a white light emitting diode (LED) as a light source. A white LED group used as a light source of the backlight enables the backlight to last longer and reduces power consumption.

The display unit 12 is attached to hinges (support portions) 25A and 25B provided at rear ends of the computer body 12. The display unit 12 is thus freely pivotable between an open position where it covers a top surface of the computer body 11 and a closed position where the top surface of the computer body 12 is exposed. The computer body 11 has a thin box-like housing and includes a keyboard 13, a power button 14, an input operation panel 15, and a touch pad 16 on its top surface; the power button 14 allows the computer 10 to be powered on and off.

The input operation panel 15 is an input device that inputs an event corresponding to a depressed button. The input operation panel 15 comprises a plurality of buttons that allow the respective functions to be started. The group of buttons includes a luminance control button 15A.

The luminance control button 15A is a button switch that allows the display luminance of LCD 17, that is, the luminance of the white LEDs. The luminance control button 15A depressed by a user generates an event instructing the luminance of the white LEDs to be increased (higher luminance) or reduced (lower luminance). The computer 10 has a luminance control function for switching the luminance of the white LEDs among eight levels, display luminance levels 8 to 1. In the present embodiment, every depression of the luminance control button 15 A by the user toggles the luminance of the white LEDs from the display luminance level 8 through 7, 6, 5, 4, 3, and 2 to 1 and then back to 8.

Now, the system configuration of the computer 10 will be described with reference to FIG. 2.

As shown in FIG. 2, the computer 10 comprises CPU 111, a north bridge 112, a main memory 113, graphics processing unit (GPU) 114 serving as a graphics controller, a south bridge 119, a BIOS-ROM 120, a hard disk drive (HDD) 121, an embedded controller/keyboard controller (EC/KBC) IC 124, and a power supply controller 125.

The CPU 111 is a processor that controls the operation of the computer 10 and executes an operating system (OS) and various application programs which are loaded from the hard disk drive (HDD) 121 to the main memory 113.

The CPU 111 also executes the BIOS (Basic Input Output System) stored in the BIOS-ROM 120. BIOS is a program for hardware control. The BIOS has a function for controlling the display luminance of the white LED group. The BIOS uses a luminance control table to control the luminance of the white LEDs. The luminance control table has set luminance control data corresponding to the display luminance levels 8 to 1.

The north bridge 112 is a bridge device that connects a local bus for the CPU 111 to the south bridge 119. The north bridge 112 is provided with a luminance control register 112A serving as hardware logic that controls the display luminance and a pulse width modulation (PWM) circuit 112B serving as a generating circuit. The luminance control register 112A is an I/O register that is readable and writable by the CPU 111. The BIOS writes luminance control data corresponding to a target display luminance level to the luminance control register 112A. The PWM circuit 112B generates a PWM signal as a luminance control signal corresponding to luminance control data written to the luminance control register 112A. The duty ratio of the PWM signal varies depending on the value for luminance control data. The PWM signal generated by the PWM circuit 112B is sent to a LED driving circuit 20 provided in the display unit 12.

The LED driving circuit 20 drives the white LED group 19, which is attached to one end of a waveguide plate 18 provided on a rear surface of LCD 17. The waveguide plate 18 allows light from the white LED group 19 to be emitted like a plane. The waveguide plate 18 and the white LED group 19 constitute a backlight. The LED driving circuit 20 has a plurality of power supply control circuits. Each of the power supply control circuits functions as a boost DC-DC converter. To adjust the value of a current flowing through the white LED group 19, the power supply control circuit adjusts the value of a driving voltage supplied to the white LED group 19 in accordance with a PWM signal transmitted by the PWM circuit 112B.

The north bridge 112 contains a memory controller that controls accesses to the main memory 113. The north bridge 112 also has a function for executing communication with the graphics controller 114 via an Accelerated Graphics Port (AGP) bus or the like.

The graphics controller 114 is a display controller that controls LCD 17, used as a display monitor for the computer 10. The graphics controller 114 has a video memory (VRAM) 114A. The graphics controller 114 generates a video signal forming a display image to be displayed on LCD 17 of the display unit 12, from display data written to the video memory 114A by OS or any application program.

The south bridge 119 controls devices on an Low Pin Count (LPC) bus. The south bridge 119 also contains an Integrated Drive Electronics (IDE) controller that controls HDD 121 and ODD 122. The south bridge 119 further has a function for controlling accesses to the BIOS-ROM 120.

The HDD 121 is a storage device that stores various software and data. The HDD 121 stores the above operating system and application programs.

An embedded controller/keyboard controller (EC/KBC) IC 124 is a one-chip microcomputer having an embedded controller and a keyboard controller integrated together; the embedded controller manages power and the keyboard controller controls the keyboard (KB) 13 and touch pad 16. When the user depresses a luminance control button 15A, the embedded controller/keyboard controller (EC/KBC) IC 124 generates an-interrupt signal, for example, system management interrupt (SMI), in order to notice BIOS of input of a display luminance switching event. The embedded controller/keyboard controller (EC/KBC) IC 124 has a function for cooperating with the power supply controller 125 in powering on and off the computer 10 in response to the user's operation of the power button 14.

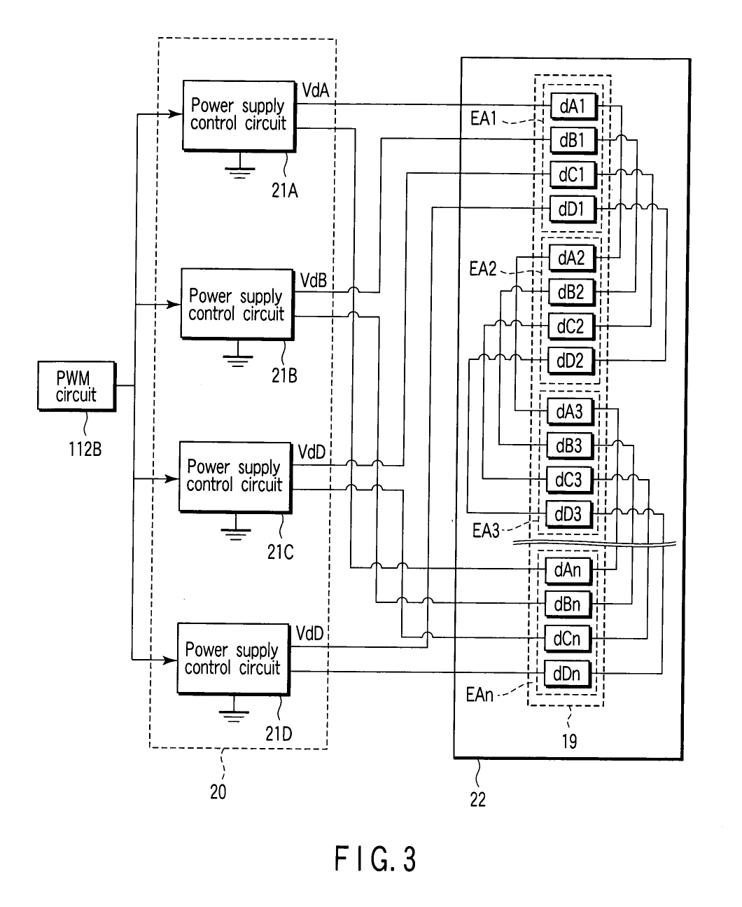

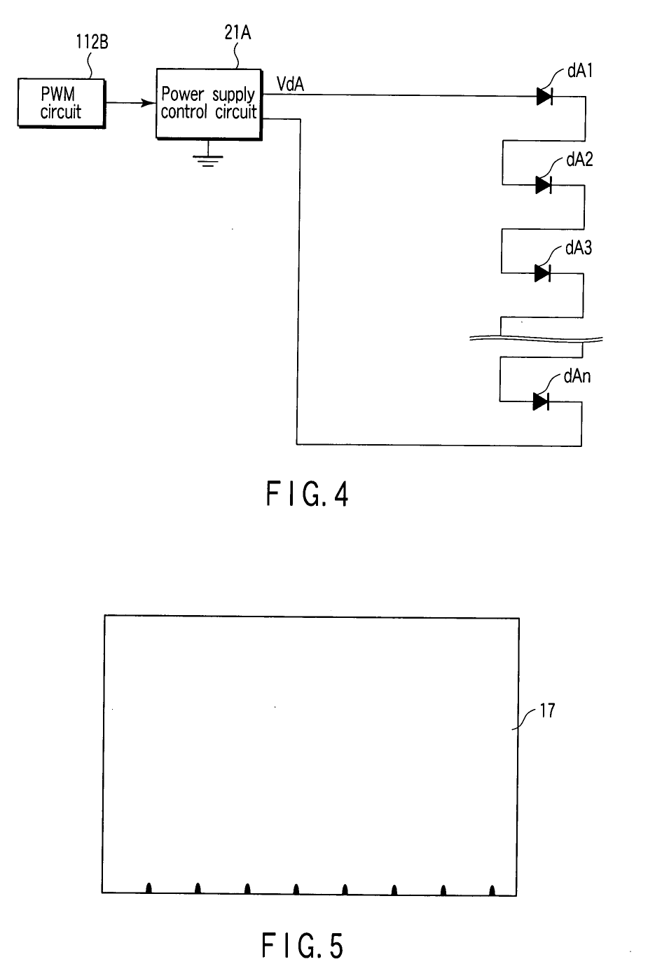

Now, with reference to FIGS. 3 and 4, description will be given of configuration of the white LED group 19 and LED driving circuit 20. The white LED group 19 is composed of a plurality of white LEDs implemented on a printed circuit board 22 in one direction; the printed circuit board 22 having a plurality of wiring layers. A plurality of emission areas EA1, EA2, EA3, . . . , and EAn are set in the area in which the white LEDs are implemented. The printed circuit board 22 may be replaced with a flexible printed circuit board.

The first emission area EA1 has white LEDs dA1 (first light emitting element), dB1 (second light emitting element), dC1, . . . , dD1 arranged in this order. The second emission area EA2 has white LEDs dA2 (third light emitting element), dB2 (fourth light emitting element), dC2, . . . , dD2 arranged in this order. The second emission area EA2 has white LEDs dA2 (third light emitting element), dB2 (fourth light emitting element), dC2, . . . , dD2 arranged in this order. The emission area EA3 has white LEDs dA3, dB3, dC3, . . . , dD3 arranged in this order. The emission area EAn has white LEDs dAn, dBn, dCn, . . . , dDn arranged in this order.

The white LEDs dA1, dA2, dA3, . . . , dAn are connected in series. The white LEDs dB1, dB2, dB3, . . . , dBn are connected in series. The white LEDs dC1, dC2, dC3, . . . , dCn are connected in series. The white LEDs dD1, dD2, dD3, . . . , dDn are connected in series.

The opposite ends of the series-connected white LEDs dA1, dA2, dA3, . . . , dAn, that is, an anode of the white LED dA1 and a cathode of the white LED dAn, are connected to the corresponding power supply control circuit 21A in the LED driving circuit 20. The opposite ends of the series-connected white LEDs dB1, dB2, dB3, . . . , dBn, that is, an anode of the white LED dB1 and a cathode of the white LED dBn, are connected to the corresponding power supply control circuit 21B in the LED driving circuit 20. The opposite ends of the series-connected white LEDs dC1, dC2, dC3, . . . , dCn, that is, an anode of the white LED dC1 and a cathode of the white LED dCn, are connected to the corresponding power supply control circuit 21C in the LED driving circuit 20. The opposite ends of the series-connected white LEDs dD1, dD2, dD3, . . . , dDn, that is, an anode of the white LED dD1 and a cathode of the white LED dDn, are connected to the corresponding power supply control circuit 21D in the LED driving circuit 20.

The white LEDs in each emission area EAi (i=1, 2, 3, . . . , n) are arranged according to the power supply control circuits 21A, 21B, 21C, and 21D, which supplies driving voltages to the white LEDs.

The power supply control circuit 21A has a function for sensing a current flowing through the series connected white LEDs dA1, dA2, dA3, . . . , dAn. The cathode side of the white LEDs dA1, dA2, . . . , dA3 is not connected to the ground. This enables the power supply control circuit 21A to accurately sense the current flowing through the white LEDs dA1, dA2, dA3, . . . , dAn without being affected by currents flowing through the white LEDs connected to the other power supply control circuits 21B, 21C, and 21D. The power source control circuit 21A adjusts the value of a driving voltage VdA so as to regulate the current value on the basis of the duty ratio of a PWM signal input to the power supply control circuit 21A as a luminance control signal as well as the sensed current value.

The power supply control circuit 21B has a function for sensing a current flowing through the series connected white LEDs dB1, dB2, dB3, . . . , dBn. The cathode side of the white LEDs dB1, dB2, . . . , dB3 is not connected to the ground. This enables the power supply control circuit 21B to accurately sense the current flowing through the white LEDs dB1, dB2, dB3, . . . , dBn without being affected by currents flowing through the white LEDs connected to the other power supply control circuits 21A, 21C, and 21D. The power source control circuit 21B adjusts the value of a driving voltage VdB so as to regulate the current value on the basis of the duty ratio of a PWM signal input to the power supply control circuit 21B as a luminance control signal as well as the sensed current value.

The power supply control circuit 21C has a function for sensing a current flowing through the series connected white LEDs dC1, dC2, dC3, . . . , dCn. The cathode side of the white LEDs dC1, dC2, . . . , dC3 is not connected to the ground. This enables the power supply control circuit 21C to accurately sense the current flowing through the white LEDs dC1, dC2, dC3, . . . , dCn without being affected by currents flowing through the white LEDs connected to the other power supply control circuits 21A, 21B, and 21D. The power source control circuit 21C adjusts the value of a driving voltage VdC so as to regulate the current value on the basis of the duty ratio of a PWM signal input to the power supply control circuit 21C as a luminance control signal as well as the sensed current value.

The power supply control circuit 21D has a function for sensing a current flowing through the series connected white LEDs dD1, dD2, dD3, . . . , dDn. The cathode side of the white LEDs dD1, dD2, . . . , dD3 is not connected to the ground. This enables the power supply control circuit 21D to accurately sense the current flowing through the white LEDs dD1, dD2, dD3, . . . , dDn without being affected by currents flowing through the white LEDs connected to the other power supply control circuits 21A, 21B, and 21C. The power source control circuit 21D adjusts the value of a driving voltage VdD so as to regulate the current value on the basis of the duty ratio of a PWM signal input to the power supply control circuit 21B as a luminance control signal as well as the sensed current value. The value for the luminance control signal indicates the value for the PWM signal generated by the PWM circuit 112B.

As shown in FIG. 3, currents following through the white LEDs within the same emission area are controlled by the separate power supply driving circuits. This corrects uneven luminance to enable stable driving even with a variation among LED elements. The power supply control circuits 21A, 21B, 21C, and 21D can accurately sense currents flowing through the white LEDs. This provides an accurate feedback based on the detected current, thus correcting uneven luminance.

If conventional white LEDs are used as a light source, the white LEDs within the same emission area are driven by the same power supply driving circuit. A terminal through which a driving voltage is supplied to the white LEDs is often provided at an end of the printed circuit board. Consequently, the length of a wiring pattern that connects the terminal to the series connected white LEDs varies among the emission areas. However, owing to the resistance of the wiring pattern, the varying wiring pattern length significantly varies the driving voltage among the emission areas (power supply control circuits). As a result, the luminance is likely to vary among the emission areas.

In the present embodiment, the white LEDs within the emission area are driven by the different power supply control circuits. Consequently, the following wiring patterns has the same length: one that connects the white LEDs dA1, dA2, dA3, . . . , dAn in series, one that connects the white LEDs dB1, dB2, dB3, . . . , dBn in series, one that connects the white LEDs dC1, dC2, dC3, . . . , dCn in series, and one that connects the white LEDs dD1, dD2, dD3, . . . , dDn in series. This makes the luminance within the surface of the LCD 17 uniform without significantly varying the driving voltage among the power supply control circuits.

With the conventional white LEDs used as a light source, the white LEDs within the same emission area are driven by the same power supply driving circuit. If the white LEDs within any emission area cannot be illuminated, block-like unrecognizable parts may occur on the screen. However, in the present embodiment, if the white LEDs connected to any power source control circuit cannot be illuminated, block-like unrecognizable parts are avoided as shown in FIG. 5. Consequently, information displayed on the LCD 17 can be recognized.

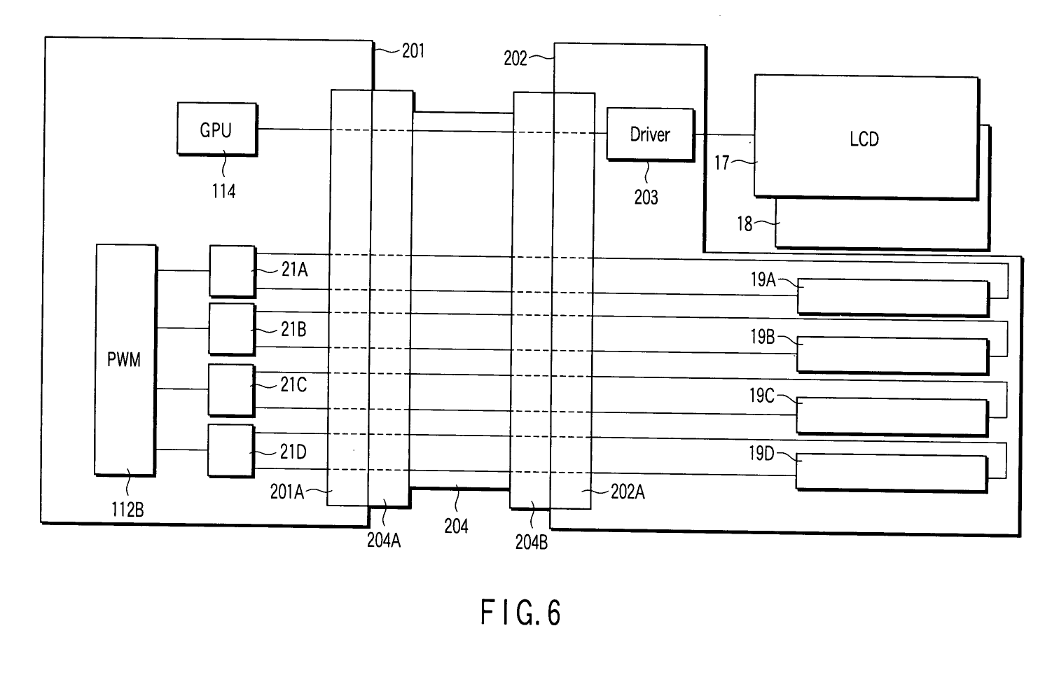

As described above, The GPU 114 and LED driving circuit 20 are provided inside the computer body 11; GPU 114 supplies video signals to the LCD 17 in the display unit 12, and the LED driving circuit 20 supplies driving voltages to the LCD groups 19 in the display unit 12. As shown in FIG. 6, the GPU 114 and LED driving circuit 20 are implemented on a system board 201. The CPU 111, north bridge 112, memory 113, south bridge 119, BIOS-ROM 120, and EC/KBC 124 are implemented on the system board 201.

A white LED group 19A (dA1 to dAn), a white LED group 19B (dB1 to dBn), a white LED group 19C (dC1 to dCn), and a white LED group 19D (dD1 to dDn) are implemented on a panel-side board 202. An LCD driver circuit 203 is implemented on the panel-side circuit board 202 to display videos on the LCD 17 in accordance with video signals supplied by GPU 114.

Video signals and driving voltages from the system circuit board 201 are supplied to the panel-side circuit board 202 through one cable 204. The cable 204 passes through one of the hinges 25A and 25B. A first connector 204A of the cable 204 is inserted into a socket 201A provided in the system circuit board 201 and serving as a first terminal. A second connector 204B of the cable 204 is inserted into a socket 202A provided in the panel-side circuit board 202 and serving as a second terminal.

Supplying video signals and driving voltages through the single cable 204 facilitates shielding of electromagnetic waves leaking from the cable 204. This in turn allows electromagnetic waves to be easily prevented.

A computer using a fluorescent tube as a light source for the LCD 17 uses a high voltage to drive the fluorescent tube. Accordingly, for a driving signal line for the fluorescent tube, the number of electric wires that can be laid in the hinge portion (connecting operative portion between the LCD section and the main section) is limited. Further, it is necessary to avoid using the same path as that for other signals, for the driving signal line in order to ensure creepage distance. Thus, a fluorescent inverter that generates a driving signal for the fluorescent tube cannot be provided inside the computer body 11.

The present embodiment uses the white LEDs for the backlight for the LCD 17. A lower driving voltage required for the white LED eliminates the need to ensure the creepage distance. This enables a driving voltage line and a signal line to be contained in one cable that can be laid in the hinge; the driving voltage for the LED flows through the driving voltage line, and the video signal flows through the signal line.

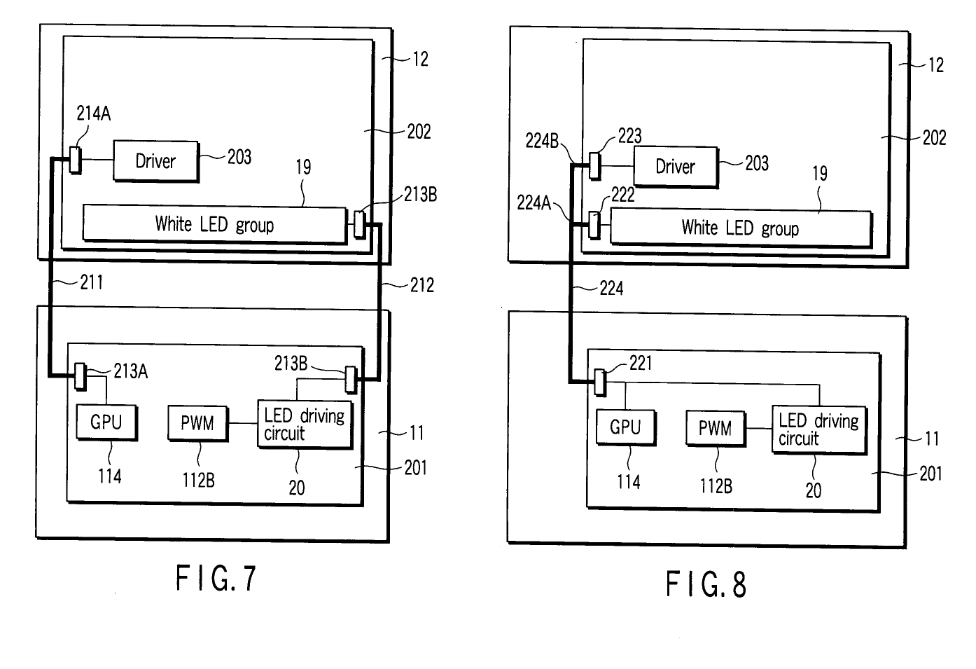

In the example shown-in FIG. 6, the video signal and driving voltage are transmitted through one cable 204. However, as shown in FIG. 7, it is possible to provide a cable 211 through which the video signal is transmitted and a cable 212 through which the driving voltage is transmitted. In this case, sockets 213A and 213B serving as a first and second terminals, respectively, is provided in the system circuit board. Sockets 214A and 214B serving as a third and fourth terminals, respectively, are provided in the panel-side circuit board 202. One end of the cable 211 is inserted into the socket 213A. The other end of the cable 211 is inserted into the socket 214A. One end of the cable 212 is inserted into the socket 213B. The other end of the cable 212 is inserted into the socket 214B. This example is effective if only a narrow space is present inside the hinges 25A and 25B and if both the video signal and driving voltage cannot be transmitted through one cable. In FIG. 7, the LCD circuit 203 and white LED group 19 are implemented on the same circuit board 202. However, the LCD circuit 203 and white LED group 19 may be implemented on different circuit boards.

Further, as shown in FIG. 8, one socket 221 serving as a first terminal may be provided in the system circuit board 201, while two sockets 222 and 223 may be provided in the panel-side circuit board 202. A cable 224 through which the video signal and driving voltage are supplied may then be forked into cables 224A and 224B in the display unit 12. The cable 224A may be connected to the socket 222 serving as the third terminal connected to the white LED group 19, whereas the cable 224B may be connected to the socket 223 serving as the second terminal connected to the LCD driver circuit 203. This is effective if in connection with wiring, the white LED group 19 and LCD driver circuit 203 cannot be connected to one socket. In FIG. 8, the LCD circuit 203 and white LED group 19 are implemented on the same circuit board 202. However, the LCD circuit 203 and white LED group 19 may be implemented on different circuit boards.

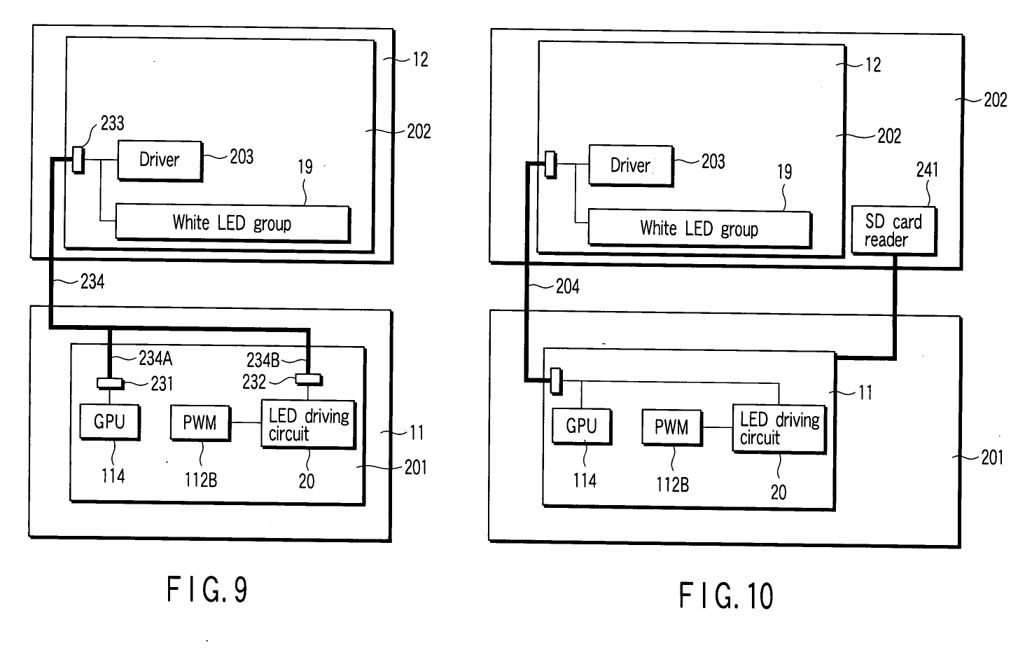

Alternatively, as shown in FIG. 9, two sockets 231 and 232 may be provided in the system circuit board 201, while one socket 233 serving as a third terminal may be provided in the panel-side circuit board 202. The cable 224 through which the video signal and driving voltage are supplied may then be forked into cables 234A and 234B in the computer body 11. The cable 234A may be connected to the socket 231 serving as the first terminal connected to GPU 114, whereas the cable 234B may be connected to the socket 232 serving as the second terminal connected to the LED driving circuit 20. This is effective if in connection with wiring, the GPU 114 and LED driving circuit 20 cannot be connected to one socket.

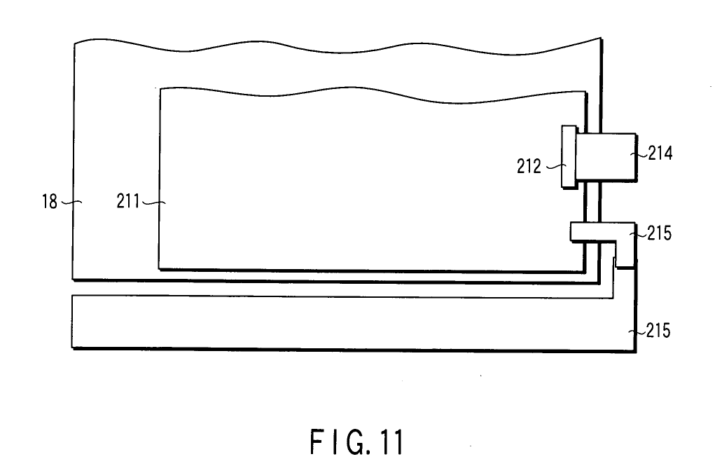

Further, as shown in FIG. 10, a fluorescent tube eliminates the fluorescent inverter circuit implemented in the display unit 12 if a fluorescent tube is used. A function for another application, for example, an SD card reader 241, can be implemented in the space in which the fluorescent inverter circuit is implemented.

Description will be given of the case in which the video signal and driving voltage are transmitted through one cable but in which the LCD driver circuit 203 and LED group 19 are implemented on different circuit boards.

If the LCD driver circuit 203 and LED group 19 are implemented on different circuit boards, then as shown in FIG. 11, the driving voltage is transmitted, via a flexible circuit board 253, from a circuit board 251 on which the LCD driver circuit is implemented to a circuit board 252 on which the white LED group 19 is implemented. A socket 255 is implemented on the circuit board 251 and connected to a cable 254 through which the video signal and driving voltage are transmitted. This connection configuration is applicable to the exemplary connection shown in FIG. 9.

In the above example, the white LEDs are used as light emitting elements. However, instead of the white LEDs, a combination of a red, green, and blue LEDs may be used to express white.

In addition, the register 112A and PWM circuit 112B may be built in South bridge 119, the embedded controller/keyboard controller (EC/KBC) IC 124, or GPU 114. The GPU 114 may be built in north bridge 114.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a body;
a display unit supported by the body;
a light source provided in the display unit and including a first area in which a first light emitting element and a second light emitting element are arranged and a second area in which a third light emitting element and a fourth light emitting element are arranged, the third light emitting element being connected in series with the first light emitting element, the fourth light emitting element being connected in series with the second light emitting element;
a first control circuit provided in the body to supply a first voltage to the first and third light emitting elements; and
a second control circuit provided in the body to supply a second voltage to the second and fourth light emitting elements.

2. The information processing apparatus according to claim 1, further comprising a graphics controller provided in the body to generate a video signal; and
a circuit board provided in the body and on which the graphics controller, the first control circuit, and the second control circuit are implemented.

3. The information processing apparatus according to claim 1, further comprising:
a first terminal provided in the body and connected to the first and second control circuits;
a second terminal provided in the display unit and connected to the first, second, third, and fourth light emitting elements; and
a cable having one end connected to the first terminal and the other end connected to the second terminal.

4. The information processing apparatus according to claim 3, further comprising a graphics controller provided in the body to generate a video signal; and
a driver circuit provided in the display unit to drive the display panel in accordance with the video signal,
wherein the first terminal is connected to the graphics controller, and
the second terminal is connected to the driver circuit.

5. The information processing apparatus according to claim 3, further comprising a graphics controller provided in the body to generate a video signal;
a third terminal provided in the body and to which the graphics controller is connected;
a driver circuit provided in the display unit to drive the display panel in accordance with the video signal;
a fourth terminal provided in the display unit and connected to the driver circuit; and
a second cable having one end connected to the third terminal and the other end connected to the fourth terminal.

6. The information processing apparatus according to claim 1, further comprising a graphics controller provided in the body to generate a video signal;
a first terminal provided in the body and on which the graphics controller, the first control circuit, and the second control circuit are implemented;
a driver circuit provided in the display unit to drive the display panel in accordance with the video signal;
a second terminal provided in the display unit and connected to the driver circuit;
a third terminal provided in the display unit and connected to the first, second, third, and fourth light emitting elements; and
a cable having one end connected to the first terminal and the other end forked into two parts one of which is connected to the second terminal and the other of which is connected to the third terminal.

7. The information processing apparatus according to claim 1, further comprising a graphics controller provided in the body to generate a video signal;
a first terminal provided in the body and to which the graphics controller is connected;
a second terminal provided in the body and to which the first and second control circuits are connected;
a driver circuit provided in the display unit to drive the display panel in accordance with the video signal;
a third terminal provided in the display unit and connected to the driver circuit and to the first, second, third, and fourth light emitting elements; and
a cable having one end forked into two parts one of which is connected to the first terminal and the other of which is connected to the second terminal, and the other end connected to the third terminal.

8. The information processing apparatus according to claim 7, further comprising:
a generating circuit which generates a luminance control signal,
wherein the first control circuit includes a circuit which adjusts a value for a current passed through the first and third light emitting elements on the basis of the luminance control signal generated by the generating circuit and a value for a current flowing through the first and third light emitting elements, and
the second control circuit includes a circuit which adjusts a value for a current passed through the second and fourth light emitting elements on the basis of the luminance control signal generated by the generating circuit and a value for a current flowing through the second and fourth light emitting elements.

9. The information processing apparatus according to claim 7, wherein arrangement of the light emitting elements within the first and second areas depends on the control circuit to which the light emitting elements are connected.

10. The information processing apparatus according to claim 1, wherein the first to fourth light emitting elements are implemented on a printed circuit board having a plurality of wiring layers.
